(19) United States
(12) Patent Application Publication
(10) Pub. No.: US 2006/0170778 A1
(43) Pub. Date: Aug. 3, 2006

(54) Systems and methods that facilitate audio/video data transfer and editing

(75) Inventors: Chad E. Ely, Euclid, OH (US); Dennis J. Kucinich, Cleveland, OH (US)

Correspondence Address: AMIN & TUROCY, LLP, 1900 EAST 9TH STREET, NATIONAL CITY CENTER, 24TH FLOOR,, CLEVELAND, OH, 44114, US

(73) Assignee: Digital News Reel, LLC

(21) Appl. No.: 11/046,627

(22) Filed: Jan. 28, 2005

(51) Int. Cl. H04N 7/16; H04N 5/225

(52) U.S. Cl. 348/207.99; 725/148

(57) ABSTRACT

A system that facilitates creation and transmission of video data comprises an interface component that receives broadcast quality digital video in a substantially uncompressed, editable format for utilization in a nonlinear video editing machine, the interface component is geographically positioned in a location remote from a broadcasting station. A transfer component facilitates transfer of the digital video to a dedicated server, the server employed to distribute the digital video to one or more subscribing broadcasting stations.

### TECHNICAL FIELD

The subject invention relates generally to digital audio/video transfer and storage, and more particularly to creation, transfer, and storage of editable audio/video files of substantial size.

### BACKGROUND OF THE INVENTION

Explosive growth in communications has enabled users to receive an unprecedented amount of information. Through utilization of sophisticated communications networks, small amounts of data can be transferred from a first location to a second location in a matter of seconds. For instance, an email that contains only text can be transferred from one user in a first geographic location to a second user in a distant geographic location nearly instantaneously. In another example, individuals can search through billions of pages on the Internet through use of search engines, wherein sophisticated and ever-improving search algorithms are employed to return relevant information to a user given a query from such user. Again, with respect to small amounts of data, these search results can be provided to the user in mere seconds.

In particular contexts, however, advancements in technology have not translated to efficient creation, transfer, and storage of data. For example, it is extremely expensive to create and transfer audio and/or video data from a location remote to a broadcasting station to such broadcasting station. Generally, a mobile unit of substantial size, such as a truck or van, is deployed to a location where a newsworthy event is occurring or expected to occur. An uplink satellite dish is conventionally mounted to the mobile unit, thereby enabling transmittal of an audio and/or video stream from the mobile unit to an orbiting communications satellite. Specifically, a video camera and/or microphone is coupled to the uplink satellite dish, and audio/video obtained therefrom is transferred to such satellite dish. Thereafter, the uplink satellite dish links to the orbiting satellite, and the audio and/or video is delivered in an analog fashion to such orbiting satellite. The orbiting satellite then downlinks to a satellite dish proximate to a broadcasting location, and audio/video is received at this location by way of a disparate satellite dish. The audio/video can thereafter be broadcast in an unedited form or directed to a local storage device, where the data can thereafter be edited as desired.

Transferring this audio and/or video data from a remote location to a broadcasting station, as stated above, constitutes a considerable expense. For instance, thousands of dollars are expended each time a mobile unit with an affixed uplink satellite dish is deployed, due to costs of data transmittal, satellite upkeep costs, trucks, uplinks, downlinks, staffing and scheduling considerations, as well as insurance on the satellite dishes. There presently exists, however, no suitable alternative method for transfer of audio/video data between a mobile unit and a broadcast station. In particular, attempts have been made to compress audio/video data files and thereafter deliver such compressed files over a land-based network (e.g., the Internet). Compressed files, however, are substantially uneditable, rendering them difficult to utilize in a news-broadcasting context, for example. Specifically, news programs typically air less than one minute of video for each item of news covered in a single program. Such small amount of video, however, may be couched within a ten-minute video file. Thus, if the video is compressed, it becomes substantially difficult to obtain and edit a desired portion of the video.

Accordingly, there exists a strong need in the art for a system and/or methodology that enables creation and transmittal of uncompressed and editable audio/video data that is not associated with expenses of conventional satellite systems.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention provides systems and/or methodologies for creating and distributing substantially uncompressed video data to one or more broadcasting systems/stations. This substantially uncompressed video data is in a form readily editable by nonlinear editing machines/software. Furthermore, the subject invention can be implemented while associated with only a fraction of the cost associated with conventional systems/methodologies for creating and transferring editable video data from a remote location to a broadcasting system/station. Moreover, as the video data is not substantially compressed, quality of such video is retained (e.g., the video data is in broadcast quality).

A video camera can be utilized to obtain video of a desirable event (e.g., a newsworthy event). For instance, such video can be captured in DV format and recorded onto a digital tape. Other formats associated with high resolution and adequate frames rate for broadcasting are contemplated by the inventor of the subject invention and are intended to fall under the scope of the hereto-appended claims. Upon obtainment of the video data, such data can be relayed to a local computing device that can include editing software (e.g., a laptop, a desktop PC coupled to a mobile unit, a PDA, a cellular phone, . . . ). Thus, the computing device can be considered a local editing machine. For instance, the broadcast quality video data can be transferred from the video camera to the local editing machine by way of FireWire or other suitable video data transfer medium/protocol. Within the local editing machine the video data can be converted/encoded into a format suitable for network traversal and/or suitable for editing by a nonlinear editing machine and software associated therewith. For instance, DV data can be converted into Audio Video Interleave (AVI) formatted data and/or DV/AVI formatted data.

The broadcast quality, substantially uncompressed video data can then be delivered to a server system that may be dedicated for storage and distribution of uncompressed audio/video data. For instance, the server system can include a SCSI multiprocessor Raided server or other suitable server that can store and process a substantial amount of video data. The server system can further include security mechanisms to ensure that those accessing such server system are authorized to receive video data thereon. For instance, the server system can include a component that analyzes usernames, passwords, biometric indicia, unique identifiers, network addresses, and the like. Thus, only those subscribing to the system of the subject invention can access video data resident upon the server system. If access is authorized, uncompressed video data of broadcast quality can be delivered to the authorized requesters, and the video data can thereafter be edited by nonlinear editing machines/software.

One or more aspects of the subject invention are particularly desirable in a news-casting context. For example, rather than requiring expensive satellite equipment to be dispatched to a remote location to obtain video and distribute such video to an affiliated broadcasting station, the subject invention enables video to be obtained and transferred by way of relatively common and inexpensive computing equipment. Furthermore, the subject invention can be utilized by multiple networks, thus reducing expense associated with requiring ownership of a video data distribution system.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a high-level block diagram of a system that facilitates creation and distribution of substantially uncompressed video data to one or more broadcasting stations in accordance with an aspect of the subject invention.

FIG. 2 is a block diagram of a system that facilitates determining whether a broadcasting system is a subscriber to a video data distribution server system in accordance with an aspect of the subject invention.

FIG. 3 is a block diagram of a system that facilitates encoding and decoding of substantially uncompressed video data in accordance with an aspect of the subject invention.

FIG. 4 is a block diagram of a system that facilitates creation and distribution of substantially uncompressed video data and substantially uncompressed audio data to one or more television stations and one or more radio stations in accordance with an aspect of the subject invention.

FIG. 5 is a flow diagram illustrating a methodology for creating and distributing substantially uncompressed video data in accordance with an aspect of the subject invention.

FIG. 6 is a flow diagram illustrating a methodology for determining whether an entity is authorized to receive substantially uncompressed video data in accordance with an aspect of the subject invention.

FIG. 7 is a flow diagram illustrating a methodology for encoding and decoding substantially uncompressed video data in accordance with an aspect of the subject invention.

FIG. 8 is a flow diagram illustrating a methodology for creating and distributing substantially uncompressed audio and video data and distributing such data to related broadcasting systems in accordance with an aspect of the subject invention.

FIG. 9 is a block diagram of a system that facilitates distribution of substantially uncompressed audio/video data to subscribing broadcasting systems in accordance with an aspect of the subject invention.

FIG. 10 is an exemplary graphical user interface that can be employed in connection with the subject invention.

FIG. 11 is an exemplary computing environment that can be employed in connection with the subject invention.

FIG. 12 is an exemplary operating environment that can be employed in connection with the subject invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, a computer readable memory encoded with software instructions, and/or a computer configured to carry out specified tasks. By way of illustration, both an application program stored in computer readable memory and a server on which the application runs can be components. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

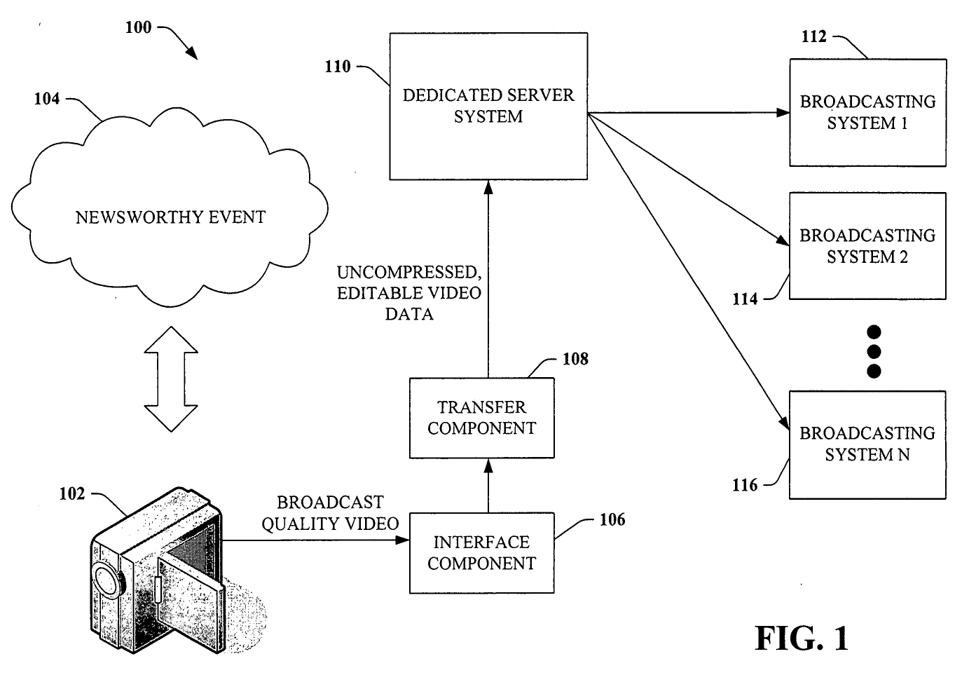

Turning now to the drawings, FIG. 1 illustrates a high-level system overview in connection with one exemplary aspect of the subject invention. More particularly, FIG. 1 illustrates a system 100 that facilitates creation, transfer, and editing of substantially uncompressed audio and/or video files. In accordance with one aspect of the subject invention, the audio and/or video files can be of substantial size. For instance, audio/video files of approximately 1 gigabyte can be of substantial size. In accordance with another aspect of the subject invention, audio/video files greater than 5 gigabytes can be of substantial size. In accordance with yet another aspect of the subject invention, audio/video files approximately equal to or greater than 20 gigabytes can be of substantial size. The system 100 includes a video camera 102 that obtains broadcast quality video, for example, of a newsworthy event, which can thereafter be transferred to an interface component 106. For example, the video camera 102 can be a digital video camera that outputs video footage in DV format, which enables encoding of video onto a tape in digital format with intraframe compression. Such encoding facilitates transfer of contents of the tape to a computer for editing purposes. Video footage in DV format is associated with greater viewing clarity when compared with conventional consumer analog formats, such as 8 mm, VHS-C and Hi-8. Furthermore, DV formatted files (or formats substantially similar thereto) are more desirable than MPEG2 files, particularly in instances where video footage is desirably edited. More particularly, MPEG2 formatted files can be considered compressed, wherein a full rendering of such files is required prior to enabling editing thereof. Such rendering adversely affects quality of an edited video file, and is thus not optimal for broadcasting or other advanced utilization.

The video camera 102 can record video footage, for example, on a miniDV and/or a DV tape. Other suitable broadcast quality formats are also contemplated by the inventor of the subject invention, and are intended to fall under the scope of the hereto-appended claims. For instance, DVCAM, DVCPRO, DVCPRO 50, DVCPRO HD, HDV, and any other suitable broadcast quality video format can be employed in connection with the subject invention. As stated above, the interface component 106 receives broadcast quality video from the video recorder 102. Such interface component 106 can enable digital video to be transferred from a tape to a local editing computer (e.g., a laptop, a desktop, a PDA, . . . ). In one example, FireWire (such as IEEE 1394 FireWire) can be utilized to transfer video (e.g., digital video) from the video camera 102 to the interface component 106. FireWire is a digital video serial bus interface standard that offers high-speed data transfer and isochronous real-time data services. Any suitable high-speed data transfer interface, however, is contemplated and intended to fall under the scope of the hereto-appended claims.

The interface component 106 can be employed in connection with converting DV formatted video (or other suitably formatted video, such as HDTV video) to another uncompressed format, wherein such format enables editing within a nonlinear editing machine without sacrificing quality of the video, and enables an owner of the video to encode such video. For example, the interface component 106 can facilitate conversion of the broadcast quality video from the video camera 106 to an Audio Video Interleave (AVI) formatted file. AVI formatted files can store audio and video data in a standard package, thereby enabling simultaneous playback of audio and video. AVI formatted files include “chunks” identified by “hdrl” tags, wherein the “chunks” can include information relating to width of video, height of video, number of frames, and other suitable metadata. AVI formatted files also include “chunks” identified by a “movi” tag, wherein the “chunks” thereby identified include audio/video data that the AVI movie comprises. Optionally, a “chunk” identified by an “idxl” tag can also be included within an AVI formatted file, wherein such “chunk” indexes location of other data chunks within such file. AVI formatted files generally, and data identified by “movi” tag(s) in particular, can be encoded and/or decoded by way of a codec, which translates between raw data and a data format within the aforementioned data chunk. Thus, AVI formatted files can carry audio/visual data in almost any suitable scheme, including uncompressed DV formatted data (e.g., Full Frames) and HDTV formatted data. It is understood, however, that AVI is merely one exemplary file format that can be employed in connection with the subject invention.

Encoding digital video data (e.g., into an AVI formatted file) can preserve a proprietary nature of digital video captured by way of the video camera 102. For instance, as stated above, data within AVI files can be encoded/decoded by way of a codec. In particular, codecs can put a stream and/or signal into an encoded form (for transmission, storage, or encryption), and thereafter decode such encoded form to enable viewing and/or editing in an appropriate format. In accordance with one aspect of the subject invention, a codec can be associated with a key, wherein an entity desirably decoding data encoded by a codec must have possession and/or knowledge of the key. Therefore, an entity that is not intended to access video from the video camera 102 can be prevented access by way of an appropriate codec and a key associated therewith. While encoding raw data is desirable, the subject invention is capable of operating desirably without transformation and/or encoding of raw audio/video data.

Upon receiving video from the video camera 102 and encoding the received video if desirable, the interface component can provide a transfer component 108 with the video data, wherein the video data is in an uncompressed format (e.g., full frame). The transfer component 108 can be employed to deliver the uncompressed, editable data to a server system 110 dedicated to storing and distributing such video data. For example, the transfer component 108 can be associated with any suitable hardware and/or software that may be employed to transfer uncompressed, editable digital video to the dedicated server system 110. In particular, the transfer component 108 can include a transceiver to facilitate communicating video data to the dedicated server system. Use of a transceiver may be particularly beneficial in connection with the subject invention, as transceivers are often employed in connection with mobile communications units. Any suitable hardware and/or software, however, that can be employed to transfer the uncompressed, editable video to the dedicated server system 110 can be utilized with respect to one or more aspects of the subject invention.

The transfer component 108 can further employ any suitable transfer protocol and transfer the video data over any suitable high-speed network connection. For instance, the File Transfer Protocol (FTP) can be utilized in connection with transferring the uncompressed, editable video data to the dedicated server system 110. FTP is a conventional software standard utilized for transferring data between machines regardless of operating systems of such machines, thereby enabling data transfer to occur efficiently and reliably. In another exemplary embodiment of the subject invention, a T1 line can be employed to transfer video data from the transfer component 108 to the dedicated server system 110. Nevertheless, other suitable connections and/or connection speeds are contemplated by the inventor of the subject invention, and are intended to fall under the scope of the hereto-appended claims.

The uncompressed, editable video data can be stored upon the dedicated server system 110 upon receipt thereof. The dedicated server system 110, for example, can include a multiprocessor Small Computer System Interface (SCSI) server system or a derivation thereof. Furthermore, the dedicated server system 110 can be a Raided system, wherein RAID (Redundant Array of Independent Disks) arrays are employed to store video data. RAID systems employ multiple data hard drives for sharing and/or replicating data amongst the drives, enabling increased data integrity, fault-tolerance, and/or performance over non-RAIDed server systems. Other suitable server systems, however, can also be employed with respect to one or more aspects of the subject invention.

The dedicated server system 110 can thereafter be employed to distribute the uncompressed, editable video data to a plurality of broadcasting systems 112-116, wherein such broadcasting systems 112-116 can desirably edit the video, for example, to enable the video to be presented within a newscast. In accordance with one particular aspect of the subject invention, the broadcasting systems 112-116 can be subscribers to the dedicated server system 110, wherein such subscribers can access any content available upon the server system 110, For instance, as mentioned briefly above, the dedicated server system 110 can include a codec that decodes video/audio data resident thereon. The codec can be distributed to the broadcasting systems 112-116 upon registration with the server system 110 and/or receipt of payment for services provided by way of the server system 110. Furthermore, a key enabling utilization of the codec can also be distributed to the broadcasting systems 112-116 in a substantially similar manner. Thereafter, the broadcasting systems 112-116 can employ their nonlinear editing machines to edit the video in a manner suitable for broadcast.

The subject invention, then, enables obtainment of broadcast quality audio/video (e.g., 720×480, 30 frames/second, . . . ) from a remote location without expenses and shortcomings of employing satellites. Furthermore, the audio/video is uncompressed, thereby allowing nonlinear editing machines to access data frame by frame, if desired. For instance, a reporting unit can be dispatched to a remote location for “on-site” reporting. A reporter can obtain broadcast quality video upon a DV tape or the like, and thereafter transfer such tape to a local editing machine (e.g., by way of firewire). The local editing machine can then be connected to the dedicated server system 110 through any suitable high-speed connection (e.g., a T1 connection). Thereafter, various broadcasting systems 112-116 can obtain this video in an uncompressed format, wherein such video is editable by nonlinear editing machines commonly utilized in news broadcasting. In contrast, conventional systems required utilization of expensive satellite equipment. A disparate alternative would be to substantially compress the audio/video data—however, compression renders the audio/video difficult to edit, as decompression algorithms can cause loss and/or distortion of data. Video resultant from such decompression is not of suitable quality for broadcast. Accordingly, the subject invention mitigates the aforementioned deficiencies through utilization of high-speed networks and the dedicated server system 110, as a significant amount of data can be uploaded to such server system 110 and distributed to a plurality of broadcasting systems in a relatively small amount of time.

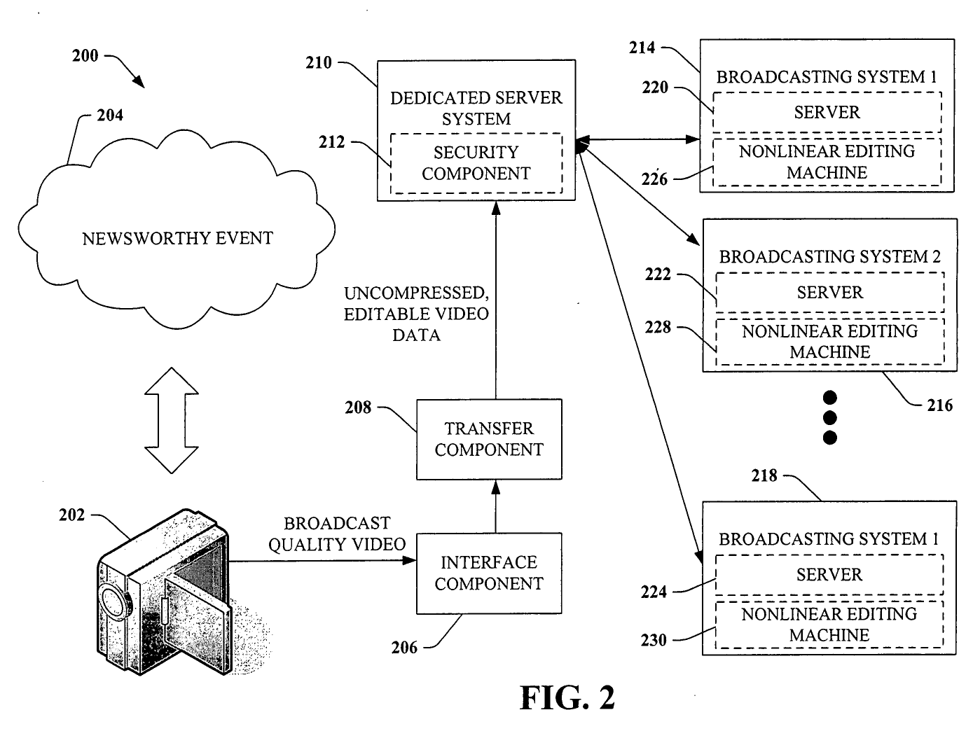

Now referring to FIG. 2, a system 200 that facilitates creation, storage, and transfer of substantially uncompressed video is illustrated. In accordance with one aspect of the subject invention, substantially uncompressed can be interpreted as reducing a file size by less than two percent. In accordance with another aspect of the subject invention, files reduced in size by approximately ten percent or less can be referred to as substantially uncompressed. In accordance with yet another aspect of the subject invention, files reduced in size by approximately twenty five percent or less can be considered as substantially uncompressed. The system 200 includes a video camera 202 that captures audio and/or video relating to a newsworthy event 204. In accordance with one particular aspect of the subject invention, the newsworthy event 204 occurs at a location geographically distant from broadcasting system(s) that desire to broadcast such audio/video. More particularly, the newsworthy event 204 can occur in a geographic location from which it is not easy to physically transfer a video tape containing audio/video relating to the event to one or more broadcasting stations.

The broadcast quality video captured by way of the video camera 202 can thereafter be transferred to an interface component 206 by way of any suitable transport mechanism/method (e.g., FireWire). In accordance with one aspect of the subject invention, the interface component 206 can facilitate interfacing the video camera 202 with a local computing machine (e.g., a laptop, PDA, or the like). A transfer component 208 can then be utilized in connection with relaying the uncompressed, editable video to a dedicated server system 210. The dedicated server system 210 can include other functions—however, such other functions should not interfere with transmission of the audio/video data. In accordance with one aspect of the subject invention, the dedicated server system 210 can be a high-end system, wherein data can be uploaded to the dedicated server system 210 at approximately 250 Megabytes per minute. This enables uncompressed, editable video files of significant size to be relayed from the video camera to the dedicated server system 210 in a matter of mere minutes.

The dedicated server system 210 is associated with a security component 212 to ensure that those uploading video data to the server system 210 and/or downloading data from the server system 210 are authorized to undertake such activities. For instance, the security component 212 can require a username and password prior to enabling a user to upload and/or download uncompressed, editable video data to/from the dedicated server system 212. If the username and password are authenticated by the security component 212, then a user/entity can be provided with access to the dedicated server system 210 (e.g., the user can upload and/or download data thereto). The security component 212 can also facilitate more granular levels of security; for instance, the security component 212 can associate disparate users and/or entities with disparate rights in connection with uploading and/or downloading uncompressed, editable video data. For one particular example, a first user may be provided access to upload no more than one gigabyte of uncompressed, editable video data over a particular period of time, while a second user may have authorization to upload four gigabytes of video data over a same period of time. Accordingly, the security component 212 can analyze access rights of individual users prior to enabling such users to upload and/or download the aforementioned video data. Alternative mechanism(s) and method(s) can also be utilized in connection with authenticating one or more users. For instance, the security component 212 can review and analyze unique identifiers associated with devices and/or network addresses, and allow uploading and/or downloading if such identifiers are authorized. This aspect of the subject invention enables user and/or device authentication to occur automatically, as the unique identifier can be pulled from devices upon a network.

In accordance with another aspect of the subject invention, the security component 212 can analyze biometric data provided by one or more users prior to enabling such user to upload and/or download audio/video data from the dedicated server system. For instance, the security component can analyze fingerprint data, voice data, eye retina data, or any other suitable biometric data that identifies one or more users. In a specific example, a microphone can be coupled to the interface component 206, and a user can provide a voice sample by way of the microphone. Digital data representative of the voice sample can be delivered to the dedicated server system 210 by way of the transfer component 208, and provided to the security component 212. The security component 212 can then analyze the voice sample together with a stored voice sample, and thereafter determine whether the user is authorized to access the dedicated server system 210. Scanning mechanisms can be employed to obtain fingerprint data, retina data, or other suitable data that uniquely identifies a user.

A plurality of broadcasting systems 214-218 can request uncompressed, editable video data that is stored upon the server system 210, and the server system 210 can relay such data to the requesting entities upon the entities being authorized by the security component 212 (as described above). For example, the broadcasting systems 214-218 may desire to air at least a portion of the video data stored upon the dedicated server system 210. Typically, however, the video data must be edited prior to broadcast. Accordingly, the authorized broadcasting systems 214-218 can be associated with local servers 220-224, respectively, which can store the uncompressed, editable video data locally. The broadcasting systems 220-224 can then employ nonlinear editing machines to edit the video obtained from the dedicated server system 210.

The subject invention thus enables transfer of uncompressed, editable, broadcast quality video from a video cameral to the nonlinear editing machines 226-230 without use of satellites and/or compressing the video data. As described above, data loss can occur during compression and decompression; therefore, resultant video may not be associated with sufficient pixel resolution and the like. Nonlinear editing machines have become desirable for video editing, as nonlinear editing offers flexibility of film editing with random access, advantages of easy project organization, and creation of new versions non-destructively. Thus, it is extremely desirable to have an ability to receive video data in an uncompressed format. Upon receipt of such video data, the nonlinear editing machines 226-230 can be employed to edit the video data as desired (e.g., frame by frame if desirable).

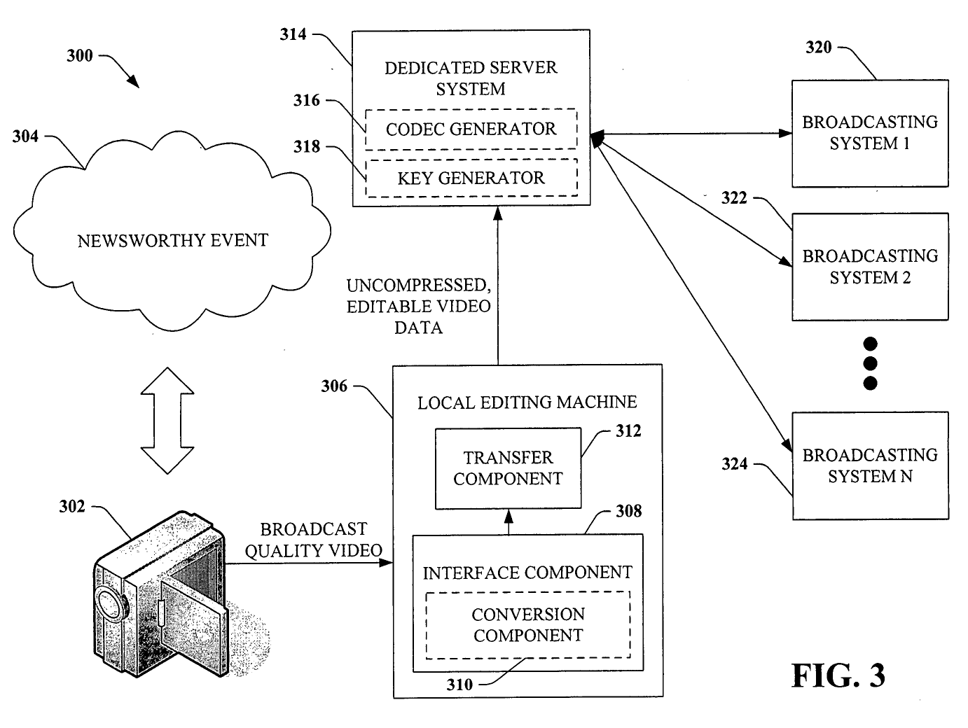

Now referring to FIG. 3, a system 300 that facilitates creation of broadcast quality video and transfer thereof to one or more remote broadcasting locations is illustrated. The system 300 includes a video camera 302 that captures a newsworthy event 304. The video camera can be any suitable camera that captures video with a sufficient quality for broadcasting. For instance, the video camera 302 can be an analog camera, so long as it is associated with an A/D converter that can convert the analog video into broadcast quality digital video. A local editing machine 306 receives the broadcast quality video, for example, through FireWire. The local editing machine includes an interface component 308 that facilitates receipt of the broadcast quality video and conversion thereof into an encoded format. For instance, the interface component 308 can be associated with a conversion component 310 that is utilized to convert the received broadcast quality video to an encoded version thereof. Such encoding secures the broadcast quality video from malicious users attempting to intercept such video, as a decoding algorithm is necessary to decode and utilize the video data. For instance, the conversion component can convert full frame DV formatted data to an AVI file, wherein the full frame, uncompressed data can reside within “chunks” of the AVI file.

The local editing machine 306 can also be employed to add breaks in a video stream and the like. Substantial nonlinear editing, however, typically takes place in a studio or the like. A transfer component 312 is associated with the interface component 308, and enables transfer of the converted, uncompressed, broadcast quality data to a dedicated server system 314. The server system 314 can be associated with a codec generator 316 as well as a key generator 318. The codec generator 316 can generate a codec and transfer it to the local editing machine 306 as well as to broadcasting systems 320-324. Thus, the local editing machine 306 can encode data with the generated codec and the broadcasting systems 320-324 can decode the video data with the generated codec. The key generator 318 can generate a key that enables the broadcasting systems 320-324 to effectively utilize the generated codec. For instance, the broadcasting systems 320-324 may be required to have possession of the key and/or have knowledge of the key before the codec will decode encoded video data.

Furthermore, the codec generator 316 can generate a new codec periodically, thereby ensuring that only those subscribing to the system 300 can decode video data from the dedicated server system 314. Thus, it may be desirable to synchronize at least the codec generator 316, the key generator 318, and the local editing machine 306 to ensure that video data encoded with a particular codec will be associated with a key generated by the key generator 318. Accordingly, a synchronization component (not shown) that enables at least the local editing machine 306 and the dedicated server system 312 and components associated therewith to synchronize with one another is contemplated. The broadcasting systems 320-324 that have access to the codec and the generated key can then receive uncompressed, editable video data from the dedicated server system 314, and edit such data on nonlinear editing machines associated therewith.

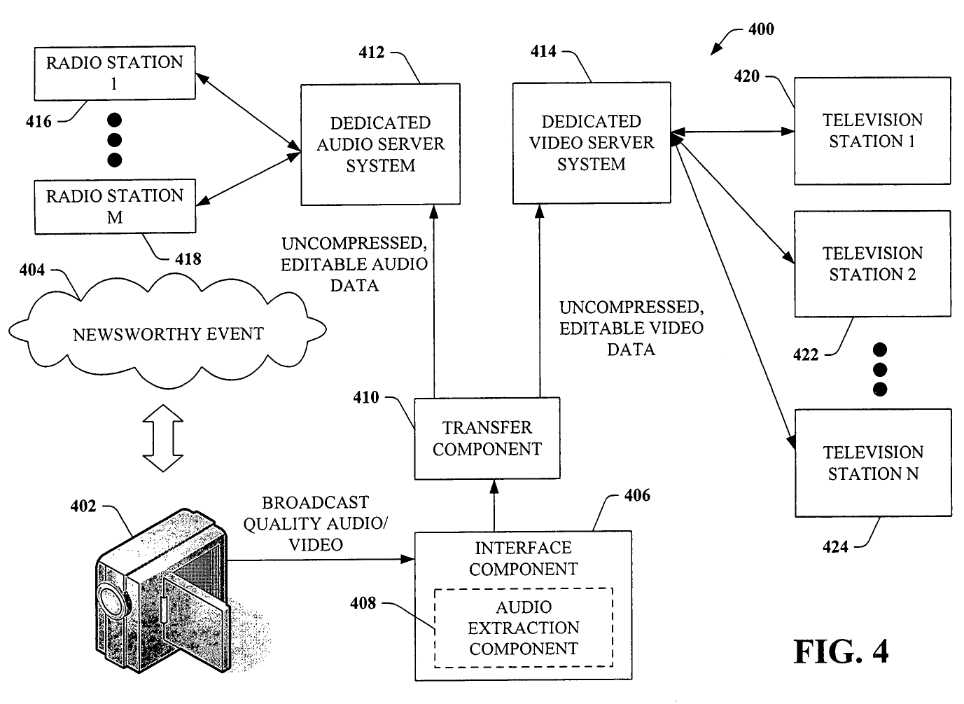

Referring now to FIG. 4, a system 400 that facilitates transfer of uncompressed, editable audio and video data from a remote location to one or more broadcasting stations is illustrated. The system 400 includes a video camera 402 that captures audio and video associated with a newsworthy event 404. Such audio and video is captured in broadcast quality in an uncompressed manner, thereby enabling nonlinear editing machines to easily edit such audio and/or video. The broadcast quality audio/video is delivered to an interface component 406 that, for instance, can be associated with a portable machine (e.g., laptop, PDA, . . . ). The interface component 406 can include an audio extraction component 408 that can extract audio from the filed delivered by way of the video camera 402. In one example, the extracted audio can be in a WAV format, which has a format similar to the AVI format. WAV files are uncompressed audio files, and are often employed in connection with professional editing. The interface component 406 is communicatively coupled with a transfer component 410 that can transfer the uncompressed, editable audio data to a dedicated audio server system 412 as well as relay the uncompressed, editable video data to a dedicated video server system 414. In an alternative aspect of the subject invention, the dedicated audio server system 412 and the dedicated video server system 414 can be combined into one server system, wherein disparate portions of the server system are dedicated for audio/video data. Furthermore, the audio extraction component 408 can exist within such combined server system.

Audio within the dedicated audio server system 412 can then be delivered to a plurality of radio stations 416-418, wherein such audio data can be edited prior to broadcast on nonlinear editing machines. For instance, uncompressed, editable audio data can be delivered to a network radio station, which can thereafter edit the audio and relay compressed versions of the edited audio to network affiliates. Furthermore, the dedicated audio server system 412 can relay uncompressed, editable audio data to both network radio stations and affiliated radio stations. The dedicated audio server system 412 can further generate and provide the radio stations 416-418 with compressed versions of the audio for long-term storage. The dedicated video server system 414 can operate in a substantially similar manner by relaying uncompressed, editable video to a plurality of television stations 420-424 that can edit the video data and thereafter broadcast the edited video. In accordance with one aspect of the subject invention, only stations subscribing to a service will be provided with access to the dedicated video server system 414 and/or the dedicated audio server system 412.

In accordance with another aspect of the subject invention, the system 400 can utilize interleaved DV and/or HDTV data, which can be partitioned into a single video stream and/or into one to four audio streams within an AVI file. Such a format is backwards compatible with numerous video-editing systems, as the format contains a standard video “vids” stream and at least one standard audio “auds” stream. The system 400 can also be employed in connection with an online broadcasting system, wherein video is streamed to a client server and thereafter broadcast by the client server over the Internet or another suitable network.

As can be easily ascertained by reviewing operability of the system 400 (and other systems described herein), applicability of various aspects of the subject invention is not limited to newscasts. For instance, video-telephone applications can employ one or more novel aspects of the subject invention. Video-telephone applications may be implemented using current telephony lines/networks, the Internet, or satellite communications. Video-telephone applications apply to telephones coupled to a monitor (such as a computer monitor) and telephones having a monitor or display as part of the telephone (such as a mobile camera telephone with an LCD display).

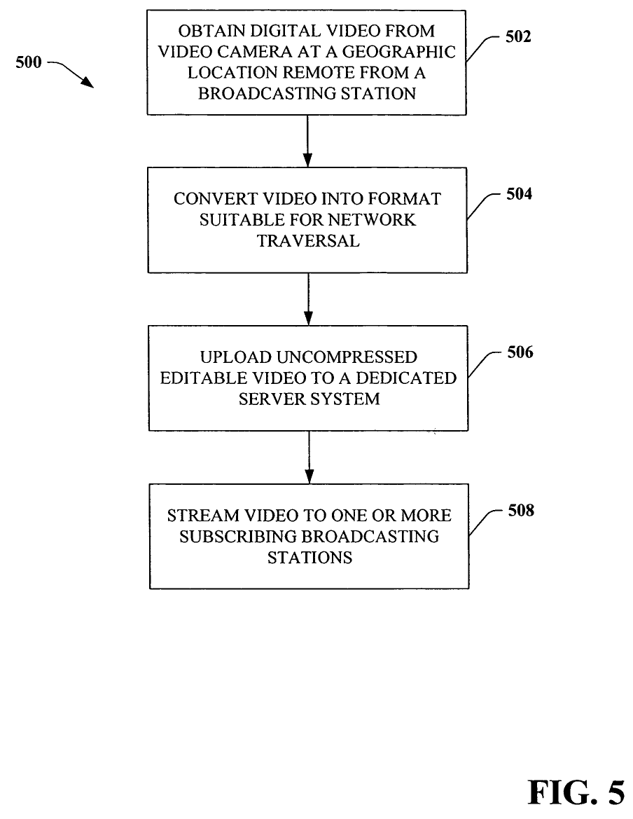

Referring now to FIGS. 5-8, various methodologies for creating and transferring uncompressed, editable video to one or more broadcasting stations is illustrated. While, for purposes of simplicity of explanation, the methodologies are shown and described as a series of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

Turning specifically to FIG. 5, a methodology 500 for transferring uncompressed, editable video over a network without utilization of expensive satellites is illustrated. At 502, digital video from a video camera is obtained, wherein the camera is at a geographic location remote from the broadcasting station. For instance, the video camera can be deployed together with a reporter in an automobile (e.g., for on-site reporting). The digital video can be in a DV format (which is an uncompressed video format), HDTV format, or any other suitable substantially uncompressed format. Thus, rather than generating compressed video (e.g., MPEG, MPEG2, . . . ) as is conventional, raw video data is retained.

At 504, the video data is converted into a format that is suitable for deliverance over a network, as well as suitable for utilization by nonlinear editing machines. Thus, for instance, it may be desirable to convert the DV-video into an AVI file, thereby enabling data therein to be encoded in a manner so that only holders of a codec utilized to encode the file can decode such file. Furthermore, full-frame data can be held within AVI files, and indexing tags can be associated therewith and include metadata relating to the full-frame data. It is understood, however, that act 504 may not be required in all circumstances, as it may be unnecessary to convert and/or encode data obtained from a digital video camera.

At 506, uncompressed, editable video is uploaded to a dedicated server system. For instance, a T1 connection or other suitable high-speed connection can be employed in connection with uploading video data. The server system can be a high-end server, such as a multiprocessor SCSI Raided server system. Furthermore, the dedicated server system can include a Direct Access Storage Device (DASD) that includes removable and replaceable disk drives through hot-swap disk bays. High-end servers enable digital video to be uploaded to the server system and downloaded from the server system at high data rates, and thus mitigate occurrences of bottlenecking associated with conventional servers/communications lines. In another example, an upload connection from a portable computing device to the server system can be dedicated, thereby further reducing occurrences of bottlenecking at the server system.

At 508, the uncompressed, editable video within the dedicated server system is streamed to one or more subscribing broadcasting stations, where the video can be edited in a manner to render it suitable for a news broadcast. For instance, nonlinear editing machines/software can be employed at the broadcasting station to edit the received video, wherein the editing can be accomplished at an extremely granular level. For instance, an individual can obtain data for a single frame and edit such frame if so desired. A subscription service can be utilized to ensure that only subscribing users/entities can access the digital video. For instance, entities paying a monetary fee can utilize the dedicated server system and access data therefrom.

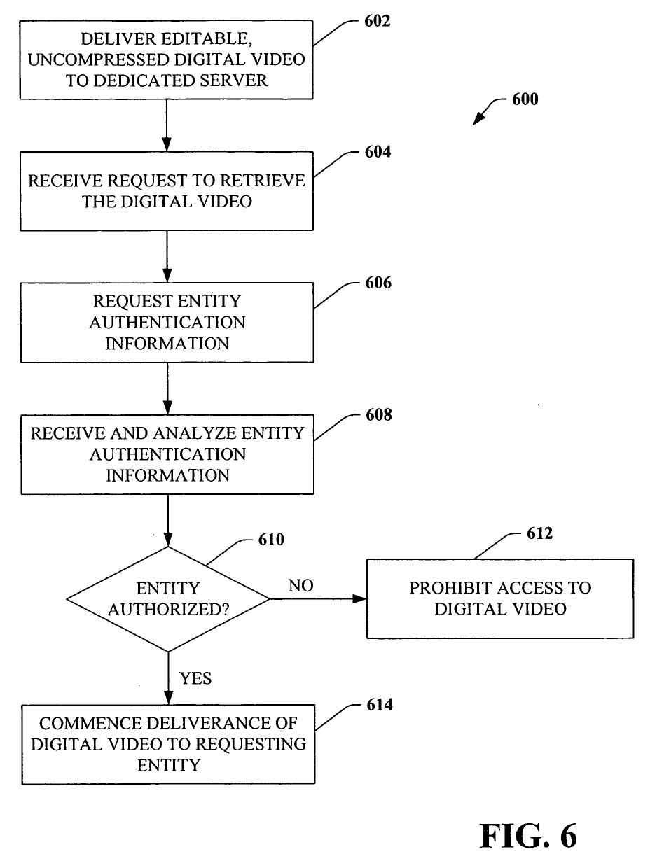

Now turning to FIG. 6, a methodology 600 for ensuring that only authorized users can access uncompressed, editable digital audio/video from a dedicated server system is illustrated. At 602, editable, uncompressed digital audio/video is delivered to a dedicated server system. At 604, a request is received at the server to retrieve the editable, uncompressed digital audio/video stored thereon. At 606, the entity requesting access to contents of the dedicated server system is queried for authentication information. Such information can include a username, password, biometric indicia, request for a unique identifier, GPS location data, or any other suitable information that can be utilized to authenticate a user/device.

At 608, entity authentication information is received at the dedicated server system and analyzed. For instance, a username and password can be analyzed, and a determination can be made regarding whether the provided username and password is valid. Similarly, a unique identifier can be pulled from one or more devices and compared with identifiers that are authorized to access contents of the dedicated server system. If biometric data is utilized to identify a user or device, the dedicated server system can compare such data against data obtained a priori to determine whether the user/device is authorized to access uncompressed, editable digital video upon the dedicated server system.

At 610, a determination is made regarding whether the entity requesting access to contents of the dedicated server system is authorized. If the entity is not authorized, the dedicated server system can prohibit the entity from accessing the digital audio/video upon the dedicated server at 612. In accordance with another aspect of the subject invention, a graphical user interface (GUI) can be provided to a user who has been denied access, wherein the GUI enables the denied user to register for the service. For instance, a credit card entry form and the like can be employed to enable a user to register with the dedicated server system and access uncompressed, unedited digital video thereon. If the entity is found to be authorized at 610, then at 614 deliverance of uncompressed, unedited digital video to the requesting entity can be commenced. Thereafter, such video can be edited upon suitable nonlinear editing machines.

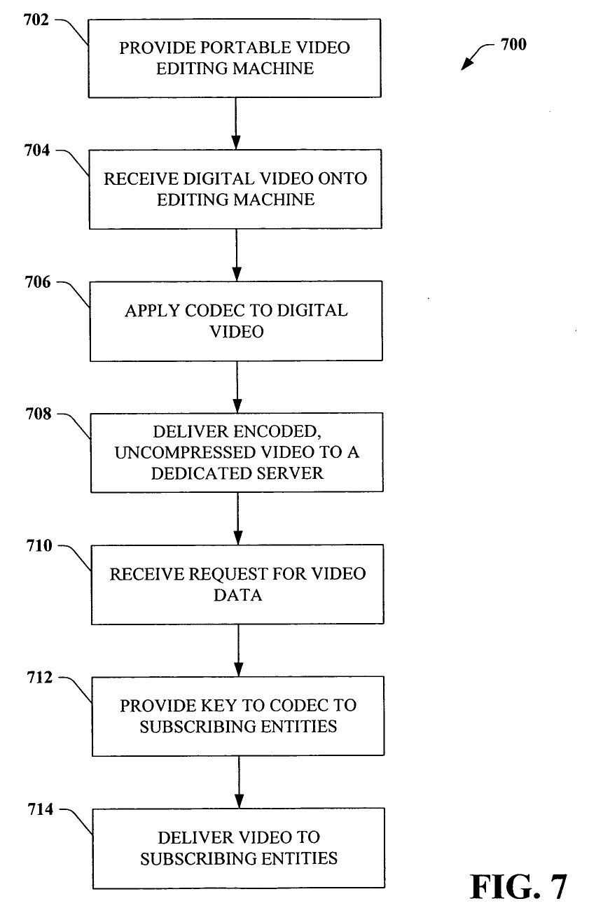

Referring now to FIG. 7, a methodology 700 for securing uncompressed, editable audio/video is illustrated. At 702, a portable video-editing machine is provided. For instance, the machine can be a laptop, a PDA, or any other suitable portable device that can be utilized as a local editing machine. At 704, the portable editing machine can receive uncompressed, editable audio/video data, for example, from a digital video recorder. FireWire or other suitable video transfer mechanism/protocol can facilitate transfer of this audio/video data to the portable editing machine. At 706, a codec is applied to the audio/video data, thereby encoding such data into, for instance, an AVI file. Other suitable file types and encodings, however, are contemplated and intended to fall within the scope of the hereto-appended claims.

At 708, encoded, uncompressed, editable video is delivered from the portable editing machine to a dedicated server system that retains such files. In particular, the encoded data remains as full-frame data. As described supra, the server system can include RAID arrays, multiple processors, and can further include other mechanisms to facilitate high-speed data transfer and storage of significant amounts of data. At 710, a request for audio/video data stored on the server is received (e.g., from a device/user associated with a broadcasting station). At 712, a key to the codec is provided to subscribing entities. Without knowledge and/or possession of such key, the uncompressed, editable audio/video data resident upon the server system is not decodable by third parties. At 714, the requested uncompressed, editable audio/video data is delivered to the subscribing entities. The key enables the entities to utilize the codec to decode the data and thereafter edit such data by way of nonlinear editing machines/software.

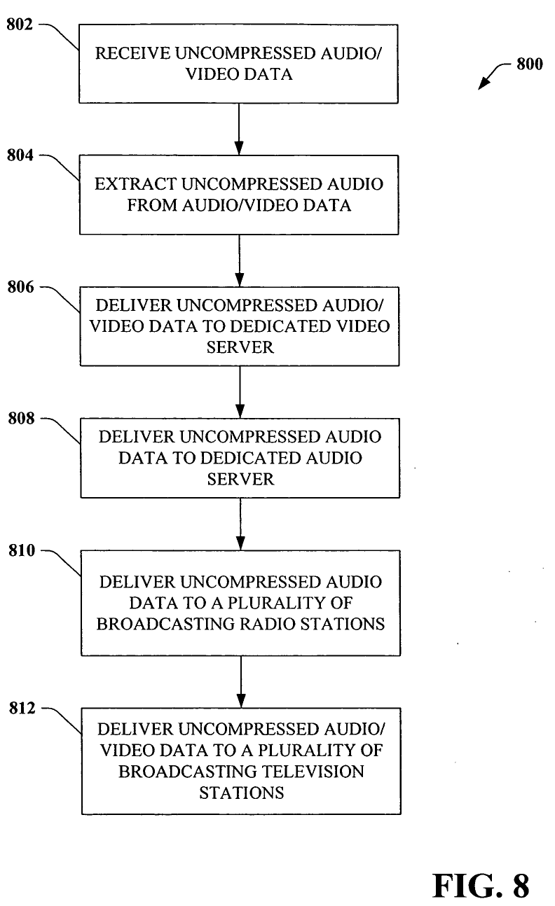

Now turning to FIG. 8, a methodology 800 for distributing uncompressed, editable audio/video data to one or more radio/television broadcasting stations is illustrated. At 802, uncompressed audio/video data is received. For instance, a local editing machine can receive broadcast-quality audio and video from a digital camera, wherein output of the camera is in DV format or HDTV format. A portable unit (e.g., a laptop) that can be utilized for local editing can receive such audio/video data. In accordance with one aspect of the subject invention, DV formatted video can be converted to a DV/AVI format, wherein the conversion does not sacrifice editability of the data. At 804, uncompressed audio can be extracted from the video data obtained by way of the digital camera. For instance, up to four audio streams can be extracted when interleaved DV data is obtained from the digital camera.

At 806, uncompressed audio/video data is delivered to a dedicated video server. For example, a suitable high-speed network connection (e.g., a T1 connection) can be employed to transfer data from a local editing machine to a dedicated video server system. Processing and storage capabilities of the server system enables data to be transferred to and transferred from such system at a high data rate, which is necessary due to substantial size of uncompressed video files. At 808, the uncompressed (extracted) audio data is delivered to a dedicated audio server system in a substantially similar manner as the uncompressed video is transferred to the dedicated server system. While the server systems have been discussed as being separate server systems, it is understood that a single server system can be employed to house both uncompressed audio and uncompressed video data. For instance, disparate storage sections within the server system(s) can be allocated for disparate uncompressed, editable data (e.g., audio data and audio/video data).

At 810, the uncompressed, editable audio data (e.g., in WAV format or the like) is delivered to a plurality of broadcasting radio stations. Upon receipt of this audio data, the radio stations can easily edit the data by way of nonlinear editing machines/software. Furthermore, such data will remain at broadcast quality and not subject to loss associated with compressing and decompressing data. At 812, uncompressed audio/video data is delivered to a plurality of broadcasting television stations. As described above, the audio/video data is in broadcast quality and is uncompressed, thereby enabling editing of such audio/video data by way of nonlinear editing machines/software. In accordance with an aspect of the subject invention, the uncompressed, editable video can be delivered to subscribing broadcasting stations upon request for such data. Moreover, payment can be obtained for each access to a video file. For instance, a user interface can be provided that requests a method of payment prior to enabling transfer of the data.

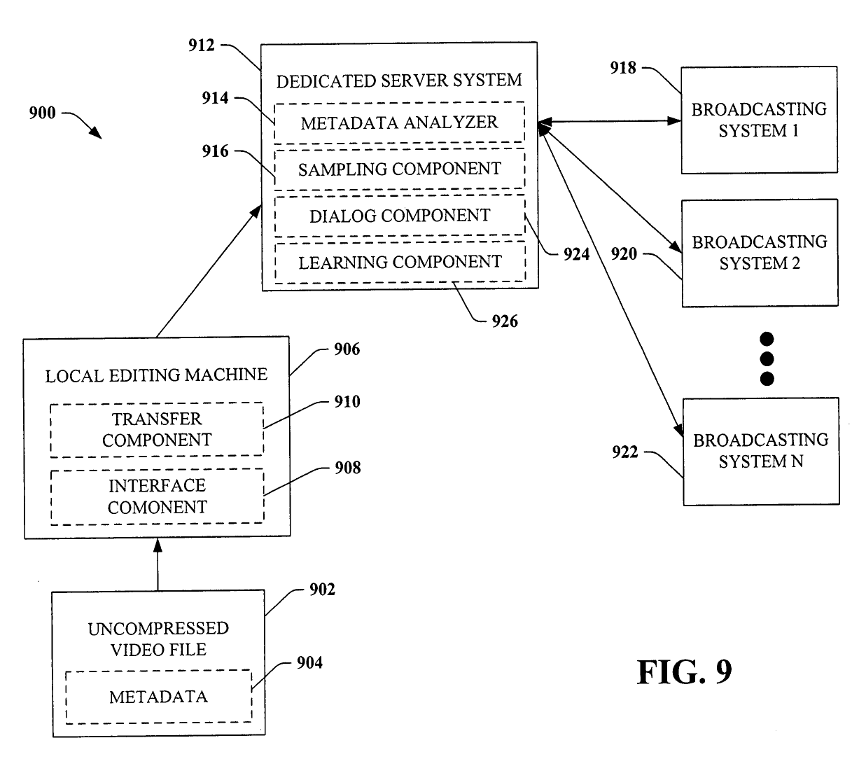

Turning now to FIG. 9, a system 900 that facilitates distribution of uncompressed, editable, broadcast quality video is illustrated. The system 900 includes uncompressed, editable video data 902 obtained from a high-end video camera. For instance, the video data 902 can be obtained from a digital video camera that creates video data in a DV format (an uncompressed, broadcast quality video format). The uncompressed video data 902 further includes metadata 904 that describes the video data 902. For instance, a GPS sensor or the like can be associated with a camera that captures the video data 902, and location of the camera at the time of capture of the data 902 can be included as metadata 904 within the video data 902. In another example, a reporter's name or other identifying indicia can be included within the metadata 904. Moreover, the metadata 904 can include indicia relating to locality of interest of the video data 902 (e.g., whether the video data 902 is of local interest, regional interest, national interest, . . . ). Further, the metadata 904 can include partitions within the video data 902 that indicate where within the video data 904 the reporter believes the most relevant data exists. Accordingly, in certain instances the metadata 904 can originate manually from a reporter (e.g., through depressing particular buttons), while in other instances the metadata 904 can originate automatically (e.g., from a GPS receiver coupled to a video camera).

The uncompressed video data 902 (and the metadata 904 therein) can then be received by a local editing machine 906, which includes an interface component 908 and a transfer component 910. The interface component 908 can facilitate receipt of the uncompressed video data 902 from, for example, a video camera. For instance, the interface component 908 can include hardware and/or software for FireWire, thereby enabling rapid transfer of the video data 902 to the local editing machine 906. Moreover, the interface component 908 can effectuate packaging of the video data 902 into a format that can be encoded and editable by nonlinear editing software. The transfer component 910 can include hardware/software to facilitate delivery of the uncompressed video data 902 to a dedicated server system 912. For instance, the transfer component 910 can include hardware/software to enable a T1 connection or other suitable high-speed connection.

The dedicated server system 912 includes a metadata analyzer 914 that analyzes the metadata 904 within the video data 902. For example, the metadata analyzer 914 can locate and recognize metadata that indicates geographic origin of the video data 902. Further, the metadata analyzer 914 can determine entered breakpoints within the video data 902, as well as determine the name of a reporter within the metadata 904, or any other suitable metadata therein. The metadata analyzer 914 can be associated with a sampling component 916 that can generate compressed samples of the video data 902. For instance, the metadata analyzer 914 can analyze the metadata 904 and locate points within the video data 902 deemed important by a reporter. The sampling component 916 can then receive this information from the metadata analyzer 914 and generate samples of the video data 904 accordingly. Thereafter, the dedicated server system 912 can distribute samples to one or more broadcasting systems 918-922, which can then decide whether the video data 902 (or portions thereof) is desirable for broadcast in a newscast.

The dedicated server system 912 can further include a dialog component 924 that enables the server system 912 to communicate with one or more of the broadcasting systems 918-922. In one particular example, the metadata 904 can include data identifying location of origin of the uncompressed video data 902. It therefore may be desirable to deliver such video data 902 only to broadcasting systems a particular distance from the identified location of origin. The dialog component 924 can deliver communications to broadcasting systems within a particular geographic proximity to the identified location of origin, informing such systems of existence of the video data. Thereafter, broadcasting systems desiring such data can effectuate a data transfer. In another example, the metadata 904 can indicate that a particular reporter generated the video data 902, and the metadata analyzer 914 can analyze the metadata 904 to determine as much. The dialog component 924 can then communicate with broadcasting system(s) affiliated with the reporter, informing them of availability of the video data 902. The dialog component 924 can further receive queries from the broadcasting systems 918-922 and locate video data based upon the queries. For instance, the dialog component 924 can receive a request for video data created by a particular reporter during a particular time frame and return video data according to the request. In another example, the dialog component 924 can receive a request for most recently created data that is available upon the dedicated server system 912, and return video data accordingly. Thus, any suitable query can be received and analyzed by the dialog component 924, and data can be located as a function of such query. The dialog component 924 can communicate by way of email, text message (to a mobile phone), instant message, or any other suitable manner of communication with a user or entity.

The dedicated server system 912 can further include a learning component 926 that monitors utilization of the dedicated server system 912 over time and “learns” intentions of particular users, entities, and/or broadcasting stations. More particularly, the learning component 926 can make inferences with respect to decisions relating to whether a particular broadcasting system should be delivered certain video data (or portions thereof). As used herein, the terms to “infer” or “inference” refer generally to the process of reasoning about or inferring states of a system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In one particular example, the learning component 926 can watch utilization of video data with respect to the first broadcasting system 918, and “learn” which video types the first broadcasting system 918 typically obtains. For instance, the first broadcasting system 918 may frequently request video data from a particular reporter when such reporter is within a specific geographic region. Thereafter, when the reporter creates video data within the geographic region (as determined by the metadata analyzer 914), the learning component 926 can inform the dialog component 924 to inform such broadcasting system 918 of existence of the aforementioned video data. In another example, the broadcasting system 920 can include multiple users, each of which receive disparate types of video data. The learning component 926 can thus watch such users and determine which type of video data each user wishes to receive (given a particular time of day, user context, user history, and the like). In a specific example, the learning component 926 can determine that a certain user only wishes to receive video data relating to sporting events at a particular time of day. The metadata analyzer 914 can analyze metadata 904 within the video data 902 and determine that the video data 902 relates to a sporting event. The learning component 926 can communicate with the metadata analyzer 914 and receive such information, and thereafter instruct the dialog component 924 to inform the user of existence of new video data relating to a sporting event upon the dedicated server system 912. The user can also receive a sample of such sporting event from the sampling component 916, and download uncompressed, editable video data relating to the sporting event if desired.

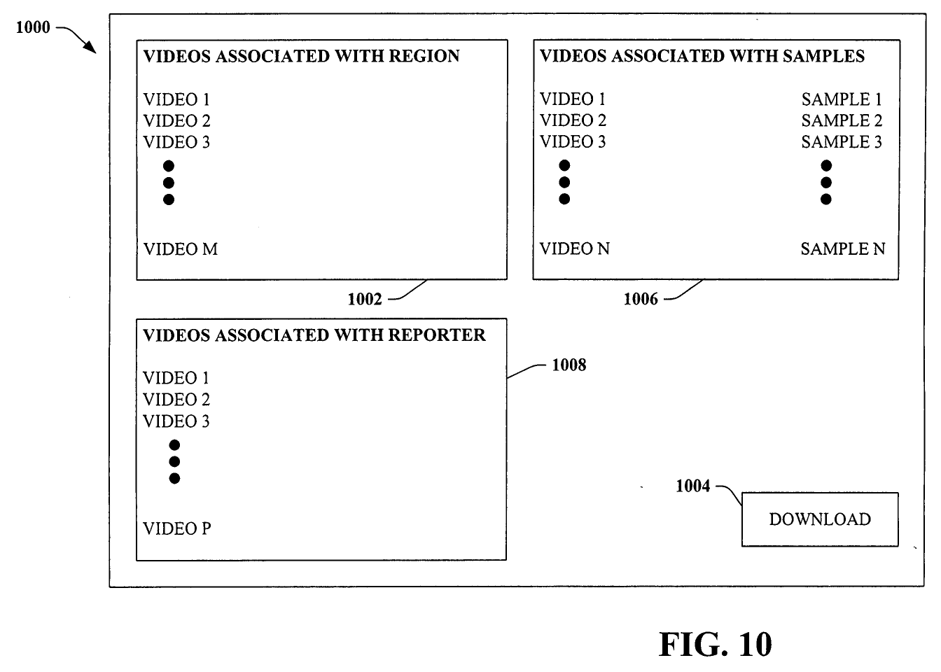

Turning now to FIG. 10, an exemplary graphical user interface 1000 that can be delivered to a broadcasting station to effectuate acquisition of uncompressed, editable video data is illustrated. The graphical user interface 1000 includes a first region that displays a plurality of available uncompressed, editable video files to a subscribing user, wherein each of the video files are associated with a particular geographic region. Thus, a broadcasting system that broadcasts local news can quickly locate video data associated with a local region. Each of the videos within the region 1002 can be selected by way of a pointing mechanism, keystrokes, or other suitable selection means. Upon depressing a “download” button 1004, the selected video(s) can be downloaded to a storage device local to the requesting broadcasting system, and the selected videos can then be edited as desired.

The user interface can further include a second region 1006 that displays to a user a plurality of videos, wherein such videos are associated with a plurality of compressed samples. Thus, rather than downloading an uncompressed video file of substantial size, a compressed portion thereof can be quickly downloaded for review. If the user reviews the sample and determines that it would be desirable to obtain the corresponding video, then such user can quickly select the video and download the video. The graphical user interface 1000 can also include a third region 1008 that includes a plurality of selectable videos that are associated with a particular reporter. Thus, broadcasting systems desiring video from such reporter can quickly select the video and download it upon selecting the button 1004. While the graphical user interface 1000 is illustrated as including the three regions 1002, 1006, and 1008, it is understood that other regions of selectable video(s) can be presented to a user within the graphical user interface 1000. Accordingly, the three aforementioned regions 1002, 1006, and 1008 are merely exemplary, and are not intended to limit the scope of the subject invention.

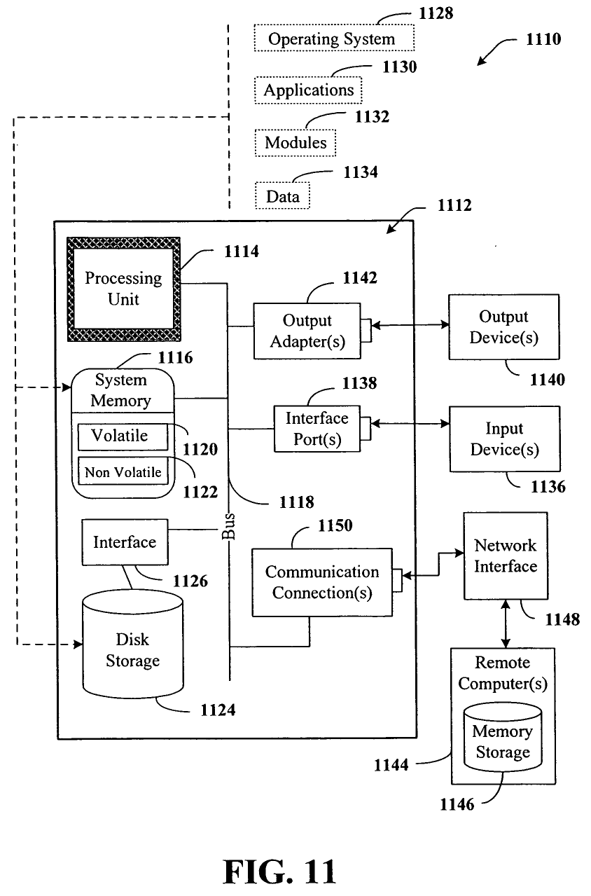

With reference to FIG. 11, an exemplary environment 1110 for implementing various aspects of the invention includes a computer 1112. The computer 1112 includes a processing unit 1114, a system memory 1116, and a system bus 1118. The system bus 118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable ROM (EEPROM), or flash memory. Volatile memory 1120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also includes removable/non-removable, volatile/non-volatile computer storage media. FIG. 11 illustrates, for example a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in suitable operating environment 1110. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the subject invention can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

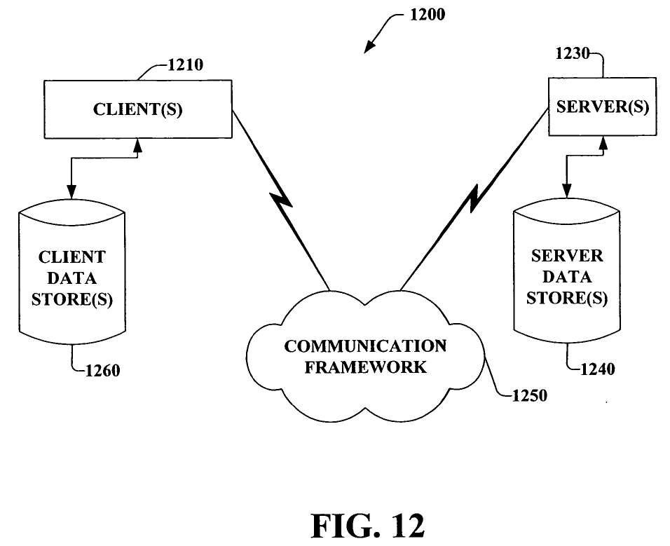

FIG. 12 is a schematic block diagram of a sample-computing environment 1200 with which the subject invention can interact. The system 1200 includes one or more client(s) 1210. The client(s) 1210 can be hardware and/or software (e.g., threads, processes, computing devices). The system 1200 also includes one or more server(s) 1230. The server(s) 1230 can also be hardware and/or software (e.g., threads, processes, computing devices). The servers 1230 can house threads to perform transformations by employing the subject invention, for example. One possible communication between a client 1210 and a server 1230 can be in the form of a data packet adapted to be transmitted between two or more computer processes. The system 1200 includes a communication framework 1250 that can be employed to facilitate communications between the client(s) 1210 and the server(s) 1230. The client(s) 1210 are operably connected to one or more client data store(s) 1260 that can be employed to store information local to the client(s) 1210. Similarly, the server(s) 1230 are operably connected to one or more server data store(s) 1240 that can be employed to store information local to the servers 1230.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates creation and transmission of video data, comprising:
an interface component that receives broadcast quality digital video in a substantially uncompressed, editable format for utilization in a nonlinear video editing machine, the interface component geographically positioned in a location remote from a broadcasting station; and
a transfer component that facilitates transfer of the digital video to a dedicated server, the server employed to distribute the digital video to one or more subscribing broadcasting stations.

2. The system of claim 1, further comprising a conversion component that converts digital video output from the video camera from a first format to a second format prior to the digital video being transferred to the dedicated server.

3. The system of claim 2, the second format is one or more of DV/AVI and HDTV/AVI.

4. The system of claim 2, the first format is one or more of DV and HDTV.

5. The system of claim 1, the digital video uploaded to a local video-editing machine by way of FireWire.

6. The system of claim 1, the dedicated server comprises a component that encodes the digital video, the digital video decoded by way of a key.

7. The system of claim 6, further comprising a subscription component that generates the key and provides the key to an authenticated user.

8. The system of claim 7, further comprising a security component that determines whether a user is authorized to access digital video within the dedicated server.

9. A method for doing business, comprising:
establishing a server system for storage and distribution of substantially uncompressed video data;
determining whether an entity requesting access to the server system is a subscriber to such server system; and
delivering substantially uncompressed data to the requesting entity if the entity is a subscriber to the server system.

10. The method of claim 9, further comprising:
capturing the uncompressed video data by way of a digital video camera; and
transferring the video data to a computing device, the computing device communicates with the server system.

11. The method of claim 9, further comprising:
extracting substantially uncompressed audio data from the video data;
delivering the audio data to a server system; and
transferring the audio data to a requesting broadcasting system that is a paid subscriber to the server system.

12. The method of claim 9, further comprising:
associating metadata with the uncompressed video data; and
selectively notifying a subscriber of existence of the video data upon the server system, the subscriber notified as a function of contents of the metadata.

13. The method of claim 12, further comprising notifying a subscriber of existence of the video data upon the server system as a function of geographic location of origin of the video data, the geographic location of origin is within the metadata.

14. The method of claim 12, further comprising notifying a subscriber of existence of video data upon the server system as a function of identity of an individual that created the video data, the identity of the individual that created the video data is within the metadata.

15. The method of claim 9, further comprising:
generating a compressed sample of the video data upon the server system; and
delivering the compressed sample to a requesting entity that is a subscriber to the server system.

16. The method of claim 9, further comprising:
encoding the video data by way of a codec; and
delivering a key to the codec to subscribers of the server system, the key enables the codec to decode the encoded video data.

17. The method of claim 9, further comprising:
compressing the substantially uncompressed video data at the server system; and
delivering the compressed video data to a web server.

18. A method for creating and distributing data in a news-casting environment, comprising:
obtaining full-frame data from a video camera, the full-frame data is in one of DV and HDTV format;
encoding the full-frame data in one of DV/AVI format and HDTV/AVI format;
relaying the full-frame data to a dedicated audio/video server system by way of a T1 network connection;
receiving a request from a subscribing broadcasting system to access the full-frame data; and
distributing the full-frame data to the broadcasting system.

19. The method of claim 18, further comprising:
receiving identifying indicia from the subscribing broadcasting system; and
analyzing the identifying indicia to determine that the broadcasting system is authorized to receive the full-frame data.

20. The method of claim 18, further comprising:
applying a codec to the full-frame data to encode such full-frame data; and
distributing the codec and a key to the subscribing entity, the key enables the codec to decode the full-frame data.
